(19) United States
(12) Patent Application Publication
(10) Pub. No.: US 2023/0286439 A1
(43) Pub. Date: Sep. 14, 2023

(54) VEHICULAR VISION SYSTEM WITH ADVANCED SAFETY VIEWS

(71) Applicant: Magna Electronics Inc., Aubum Hills, MI (US)

(72) Inventors: Jyothi P. Gali, Rochester Hills, MI (US); Alan M. Cordeiro, Farmington Hills, MI (US); Richard C. Bozich, Canton, MI (US); Nikhil Gupta, Brampton (CA); Suresh Boddi, New Hudson, MI (US)

(21) Appl. No.: 18/051,981

(22) Filed: Nov. 2, 2022

Related U.S. Application Data
(60) Provisional application No. 63/263,480, filed on Nov. 3, 2021.

(51) Int. Cl. B60R 1/27; B60R 1/12

(52) U.S. Cl. CPC B60R 1/27; B60R 1/12; B60R 2001/1253; B60R 2300/105; B60R 2300/607; B60R 2300/802; B60R 2300/804; B60R 2300/806; B60R 2300/8093

(57) ABSTRACT

A vehicular vision system includes a plurality of surround view cameras disposed at a vehicle, an electronic control unit (ECU), and a video display screen disposed in the vehicle and viewable by a driver of the vehicle for displaying video images derived from image data captured by the surround view cameras. The vehicular vision system, responsive to determining an impending lane change of the equipped vehicle toward an adjacent traffic lane and responsive to processing at the ECU of image data captured by at least one of the surround view cameras of the plurality of surround view cameras, displays on the video display video images derived at least in part from image data captured by at least two of the side view cameras. The displayed video images include a portion of the adjacent traffic lane.

### CROSS REFERENCE TO RELATED APPLICATION

The present application claims the filing benefits of U.S. provisional application Ser. No. 63/263,480, filed Nov. 3, 2021, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes a plurality of surround view cameras disposed at a vehicle equipped with the vehicular vision system that view exterior of the equipped vehicle. Each camera of the plurality of surround view cameras captures image data. The plurality of surround view cameras includes a rear backup camera disposed at a rear portion of the equipped vehicle that views at least rearward of the equipped vehicle and a forward viewing camera disposed at a front portion of the vehicle that views at least forward of the equipped vehicle. The plurality of surround view cameras includes a first sideward viewing camera disposed at a first side of the equipped vehicle that views at least sideward at the first side of the equipped vehicle and a second sideward viewing camera disposed at a second side of the equipped vehicle that views at least sideward at the second side of the equipped vehicle. Each camera of the plurality of surround view cameras includes a CMOS imaging array. Each CMOS imaging array may include at least one million photosensors arranged in rows and columns. The system includes an electronic control unit (ECU) with electronic circuitry and associated software and a video display screen disposed in the equipped vehicle that is viewable by a driver of the equipped vehicle. The video display screen is for displaying video images derived from image data captured by the plurality of surround view cameras. The electronic circuitry of the ECU includes an image processor for processing image data captured by the plurality of surround view cameras. With the equipped vehicle traveling along a traffic lane of a road, the vehicular vision system, responsive to determining an impending lane change of the equipped vehicle toward an adjacent traffic lane at the first side of the equipped vehicle, and responsive to processing at the ECU of image data captured by at least the first sideward viewing camera, displays on the video display video images derived at least in part from image data captured by (a) the first sideward viewing camera and (b) at least one selected from the group consisting of (i) the rear backup camera and (ii) the forward viewing camera. The displayed video images include a portion of the adjacent traffic lane.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates one or more cameras; and

FIG. 2 is a schematic view of the vehicular vision system of FIG. 1 displaying an advanced safety view on a display.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

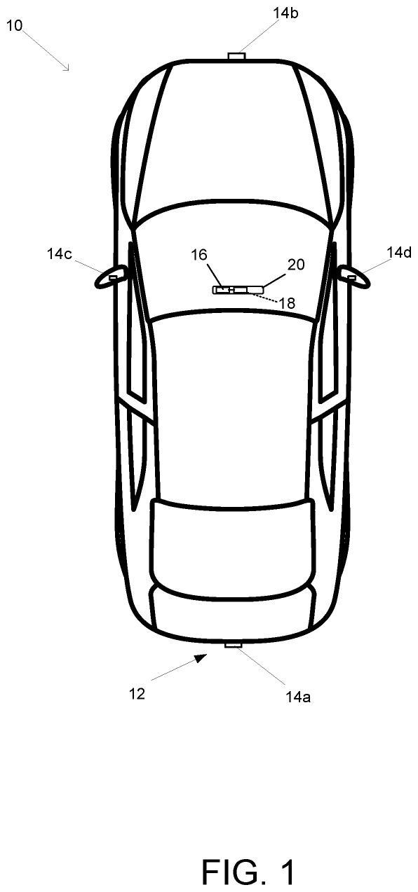

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Implementations herein include a vehicular vision system or vehicular driving assist system that informs the driver or other occupant of a vehicle equipped with the vision system about potential hazardous scenarios around the equipped vehicle while the vehicle is motion or at a standstill. The system utilizes surround view camera images (such as image data captured by cameras 14a-d of FIG. 1) to convey information to the driver when needed. For example, during a reversing maneuver, images derived from image data captured by the rear backup camera of the surround view system may be displayed, and during a parking maneuver, images derived from image data by each of the surround view cameras may be displayed, and the system may episodically display images derived from one or both side surround view cameras responsive to a triggering event, such as detection of an object at the side or blind spot region or such as actuation of a turn signal or the like. The system assists the driver in safely maneuvering the equipped vehicle by providing visual information about one or more target objects. A target object is defined as an object (e.g., another vehicle, a pedestrian, etc.) that may potentially come near and collide with or impede the equipped vehicle.

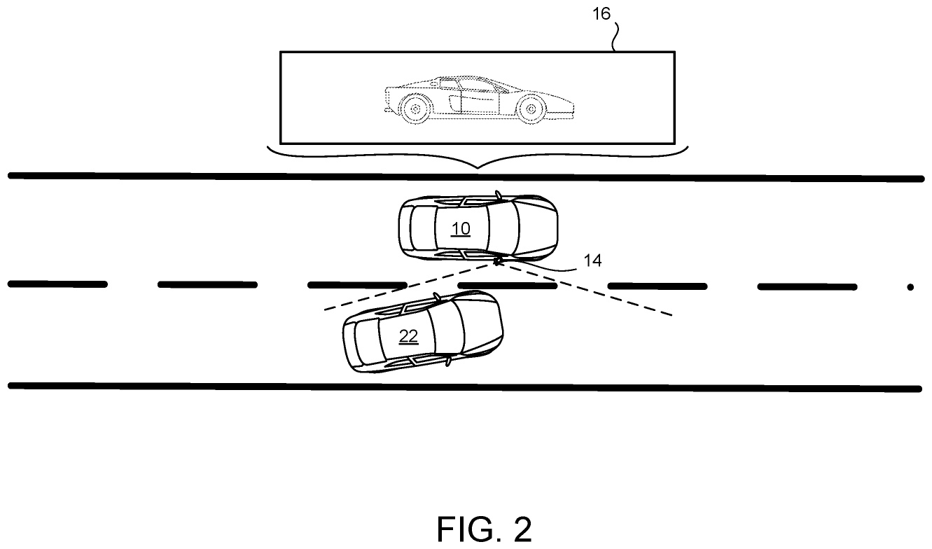

The system may include an advanced safety view (ASV) feature that provides visual feedback representative of the surroundings of the vehicle to the driver or other occupant of the vehicle. For example, the feature provides ASVs during driving scenarios such as intentional or unintentional lane changes. For example, when the vehicle, as the vehicle travels along a traffic lane, drifts or moves toward the left lane boundary such that the vehicle moves laterally at a threshold speed and/or comes within a threshold distance of the left lane boundary, the ASV feature may display a left camera view (e.g., captured by a camera viewing left of the equipped vehicle, such as camera 14c) on a display disposed within the equipped vehicle (e.g., at a dash, at a head-up display, etc.). That is, when the system detects that the equipped vehicle is moving/drifting laterally towards a left side of the traffic lane the equipped vehicle is currently traveling along (i.e., to an adjacent lane), the system displays images to the driver of the vehicle that are representative of the environment to the left of the vehicle (e.g., the lane to the left of the vehicle). As another example, the ASV feature may display a right camera view (e.g., captured by a camera viewing right of the equipped vehicle, such as camera 14d) when the system detects that the equipped vehicle is moving/drifting laterally toward a traffic lane adjacent and to the right of the current traffic lane. As yet another example, and as shown in FIG. 2, the ASV feature may display views (e.g., left views or right views) when a vehicle from another lane moves laterally closer to the equipped vehicle, such as when a vehicle in an adjacent lane comes within a threshold distance of the lane boundary shared with the traffic lane the equipped vehicle is travelling along. Here, another vehicle 22 appears to be merging into the same traffic lane the equipped vehicle 10 is traveling along. In response to this, the system displays image data captured by the camera 14 (e.g., located at the passenger-side exterior mirror) images of the other vehicle 22 on the display 16. Optionally, the display 16 may be a display associated with images captured to the right of the vehicle. Optionally, the other vehicle 22 may be displayed on the display 16 in a manner to indicate that the other vehicle 22 is to the right of the equipped vehicle 10 (e.g., by displaying the other vehicle on the right side of the display 16, by labeling the image with text or symbols indicating the other vehicle 22 is to the right, by playing an audible chime from speakers on the right side of the vehicle 10, etc.).

In another scenario, the system may provide ASVs during emergency lane keeping or lane change avoidance situations. For example, the ASV feature may display captured image data representing a view that includes surroundings of the equipped vehicle (e.g., a 2D/3D surround camera view or individual left or right camera views) when a lane keep assist (LKA) feature detects an emergency lane keep assistance event (e.g., the equipped vehicle is approaching a lane boundary) or an emergency lane change avoidance event gets triggered (e.g., another vehicle is merging into the same lane the equipped vehicle is traveling along).

In yet another scenario, the system may provide ASVs during manual or automated lane changes (i.e., when the equipped vehicle moves from the current traffic lane to an adjacent traffic lane to the left or right of the current traffic lane). For example, the ASVs may display frames of image data captured by a left/right viewing camera when the user indicates a desire to change lanes (e.g., by manually enabling a left/right turn indicator). For example, the driver indicates an imminent lane change by enabling the left turn signal. In response, the system displays an ASV that includes image data captured by a camera viewing to the left of the vehicle (e.g., on a head-up display, a dash display, etc.). In another example, the ASVs may display frames of image data captured by a left/right viewing camera when a lane change assist system determines a lane change is appropriate. For example, the ASVs may display frames of image data from a left/right viewing camera when a lane change assistance feature determines to take an exit or other ramp or when a lane change is required to follow navigation guidance, avoid traffic, avoid emergency personnel, etc.

In another exemplary scenario, the system may provide ASVs when turning (e.g., across another lane). For example, the ASV feature may display frames of image data that include a side of the equipped vehicle (such as a 2D/3D surround camera view or individual left or right camera views) to which the equipped vehicle is turning.

In other examples, the system, when another vehicle enters a blind spot zone of the equipped vehicle (e.g., an area around the vehicle not easily viewable by the driver of the vehicle) or another vehicle enters a blind spot zone of a trailer connected to the equipped vehicle, the ASV feature may display an appropriate surround camera view (such as left or right camera view, a bird's-eye-view, a vehicle 2D/3D 360 view (showing a two-dimensional or a three-dimensional avatar of the equipped vehicle and video images of the area around the vehicle avatar), trailer 2D/3D 360 view (showing a two-dimensional or a three-dimensional avatar of the equipped vehicle and trailer and video images of the area around the vehicle and trailer avatar), etc.). For example, the system may display a virtual point of view (i.e., a point of view different from any of the actual point of views of the equipped cameras by combining and translating image data from a plurality of the cameras) that includes a three-dimensional avatar of the vehicle and at least a portion of the environment surrounding the vehicle. For example, the virtual point of view may be a bird's-eye view or the like or a downward view from an elevated virtual vantage point forward and toward one side of the vehicle, such as toward the side of the vehicle opposite from the side at which another vehicle is detected, and the surrounding area may include the traffic lanes adjacent to the traffic lane the vehicle is traveling along. The position of the virtual point of view may depend upon the scenario for the ASV. For example, when the system determines an impending lane change to a lane to the left of the equipped vehicle, the virtual point of view may be positioned such that the equipped vehicle (i.e., the avatar representing the vehicle) and the traffic lane to the left of the equipped vehicle are visible in the displayed view. The 2D/3D avatar represents the location of the vehicle and the space occupied by the vehicle in the environment. When hitched to a trailer, the 2D/3D avatar may include an avatar of a trailer.

Additionally, the system may highlight the other vehicle (or other object) that has entered the blind spot by overlaying graphics on the frames of image data. When an object (e.g., a vehicle, a pedestrian, an animal, etc.) is detected as front cross traffic (i.e., crossing in front of a predicted path of the equipped vehicle), the ASV feature may display a front camera view with a graphical overlay highlighting the detected object. The graphical overlay may include or provide information about direction and relative (i.e., relative to the equipped vehicle) or absolute speed of the detected object. When an object approaches the equipped vehicle while the equipped vehicle is turning across the current traffic lane or path, the ASV feature may display a front and/or side camera view(s) with a graphical overlay highlighting the detected object. The graphical overlay may include information about the direction and relative speed of the detected object. The ASV feature may automatically enable a surround view on when the system detects or determines that the equipped vehicle is in close proximity to an object such as curb, barrier, puddle, stone, etc. The system may highlight (e.g., using a graphical overlay such as a boundary box, an arrow, text, etc.) the detected object.

The system may be enabled/disabled by an occupant of the vehicle (e.g., via actuation by the occupant of one or more user inputs or human machine interfaces (HMIs) within the vehicle). The system may be automatically enabled and/or disabled based on certain conditions. For example, when the vehicle is traveling above or below a threshold speed, based on weather conditions (e.g., raining, snowing, sunny, etc.), etc. The images may be displayed on a display in a manner to indicate a direction to the driver that the displayed images originate from. For example, when images captured from a camera viewing to the left of the vehicle are displayed, the images may be placed on a on a left display (i.e., of multiple displays) or a left-side of a single display to indicate that the images originate from the left-viewing camera. Similarly, images captured by a camera viewing to the right of the vehicle may be displayed on a right display or offset to the right of the display. Other means of indicating the direction the captured images were obtained from may be included. For example, the system may include an overlay or other notification that includes a symbol (e.g., an arrow) or text that indicates the appropriate direction. Optionally, the system includes an audible or haptic notification when displaying ASVs.

The system may operate at any speed as the vehicle travels along the road. While many conventional surround view systems disable when the vehicle is moving above a threshold speed (e.g., 7 miles per hour), the system may operate at speeds greater than 20 miles per hour, greater than 35 miles per hour, and/or greater than 50 miles per hour, etc. Thus, the system may capture, process, and display image data captured by one or more surround view cameras when the vehicle is not being parked and is moving at any speed along, for example, a highway or other road. The system may be disabled when the vehicle drops below a speed at which the typical surround view display may be activated (e.g., when the vehicle slows to a speed below 10 mph or below 7 mph or below 5 mph), whereby the display screen displays top down bird's-eye or surround view video images derived from image data captured by all of the surround view cameras.

Thus, the system provides advanced safety views (ASVs) in response to triggering scenarios and/or events. For example, the system determines when the equipped vehicle is likely to change lanes or make any other lateral movements and provides, using side viewing cameras, frames of captured image data on a display that display an area in the direction of lateral movement. The system may also respond to detected or determined objects in proximity to the equipped vehicle, such as another vehicle entering a blind spot of the equipped vehicle. Optionally, the system provides visual feedback. For example, based on the scenario or the events, the system may render an appropriate surround view (e.g., using image data captured by one or more surround view cameras disposed around the vehicle, such as side viewing cameras, forward viewing cameras, and/or rear viewing cameras). The system may render graphical overlays on the captured frames of image data to highlight objects and/or provide relevant information. The system may utilize aspects of vision systems described in U.S. Pat. No. 10,354,155 and/or U.S. Publication No. US-2018-0134217, which are hereby incorporated herein by reference in their entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a plurality of surround view cameras disposed at a vehicle equipped with the vehicular vision system and viewing exterior of the equipped vehicle, each camera of the plurality of surround view cameras capturing image data;
wherein the plurality of surround view cameras comprises a rear backup camera disposed at a rear portion of the equipped vehicle that views at least rearward of the equipped vehicle and a forward viewing camera disposed at a front portion of the vehicle that views at least forward of the equipped vehicle;
wherein the plurality of surround view cameras comprises a first sideward viewing camera disposed at a first side of the equipped vehicle and viewing at least sideward at the first side of the equipped vehicle and a second sideward viewing camera disposed at a second side of the equipped vehicle and viewing at least sideward at the second side of the equipped vehicle;
wherein each camera of the plurality of surround view cameras comprises a CMOS imaging array, and wherein each CMOS imaging array comprises at least one million photosensors arranged in rows and columns;
an electronic control unit (ECU) comprising electronic circuitry and associated software;
a video display screen disposed in the equipped vehicle and viewable by a driver of the equipped vehicle for displaying video images derived from image data captured by the plurality of surround view cameras;
wherein the electronic circuitry of the ECU comprises an image processor for processing image data captured by the plurality of surround view cameras;
wherein, with the equipped vehicle traveling along a traffic lane of a road, the vehicular vision system, responsive to determining an impending lane change of the equipped vehicle toward an adjacent traffic lane at the first side of the equipped vehicle, and responsive to processing at the ECU of image data captured by at least the first sideward viewing camera, displays on the video display video images derived at least in part from image data captured by (a) the first sideward viewing camera and (b) at least one selected from the group consisting of (i) the rear backup camera and (ii) the forward viewing camera; and
wherein displayed video images include a portion of the adjacent traffic lane.

2. The vehicular vision system of claim 1, wherein the first sideward viewing camera is disposed at a first-side exterior rearview mirror assembly of the equipped vehicle and the second sideward viewing camera is disposed at a second-side exterior rearview mirror assembly of the equipped vehicle.

3. The vehicular vision system of claim 1, wherein the vehicular vision system determines the impending lane change based on a turn signal input actuated by the driver of the equipped vehicle.

4. The vehicular vision system of claim 1, wherein the vehicular vision system determines the impending lane changed based on an output from a lane keeping function of the equipped vehicle.

5. The vehicular vision system of claim 1, wherein the vehicular vision system determines the impending lane changed based on an output from a navigation function of the equipped vehicle.

6. The vehicular vision system of claim 1, wherein the vehicular vision system determines the impending lane change based at least in part on image processing at the ECU of image data captured by any camera of the plurality of surround view cameras.

7. The vehicular vision system of claim 1, wherein the vehicular vision system, responsive to determining an impending merge of another vehicle toward the traffic lane the equipped vehicle is traveling along, and responsive to processing image data captured by at least the first sideward viewing camera, displays on the video display video images derived at least in part from image data captured by the first sideward viewing camera and at least one selected from the group consisting of (i) the rear backup camera and (ii) the forward viewing camera, and wherein the displayed video images include a portion of the other vehicle.

8. The vehicular vision system of claim 1, wherein the vehicular vision system, responsive to processing at the ECU of image data captured by at least one camera of the plurality of surround view cameras, detects another vehicle is in a blind spot of the equipped vehicle, and wherein the vehicular vision system displays on the video display video images derived at least in part from image data captured by the at least one camera of the plurality of surround view cameras, and wherein the displayed video images at least partially include the detected other vehicle.

9. The vehicular vision system of claim 8, wherein the vehicular vision system highlights the detected other vehicle in the video images using a graphical overlay.

10. The vehicular vision system of claim 9, wherein the graphical overlay comprises at least one selected from the group consisting of (i) a direction of the other vehicle and (ii) a speed of the other vehicle.

11. The vehicular vision system of claim 1, wherein the video images are derived from at least three cameras of the plurality of surround view cameras.

12. The vehicular vision system of claim 1, wherein the displayed video images comprise a simulated 360 degree bird's-eye view of the equipped vehicle.

13. The vehicular vision system of claim 12, wherein the displayed video images comprise a graphical overlay, and wherein the graphical overlay comprises a vehicular avatar representing location of the equipped vehicle within the displayed video images.

14. The vehicular vision system of claim 13, wherein the vehicular avatar comprises a three-dimensional avatar.

15. The vehicular vision system of claim 1, wherein, during a parking maneuver of the equipped vehicle, the vehicular vision system displays video images derived from image data captured by all cameras of the plurality of surround view cameras.

16. The vehicular vision system of claim 1, wherein the vehicular vision system, responsive to determining that a predicted route of another vehicle crosses a predicted path of the equipped vehicle, and responsive to processing image data captured by at least one camera of the plurality of surround view cameras, displays on the video display video images derived at least in part from image data captured by the forward viewing camera and at least one selected from the group consisting of (i) the first sideward viewing camera and (ii) the second sideward viewing camera, and wherein the displayed video images include a portion of the other vehicle.

17. The vehicular vision system of claim 1, wherein the vehicular vision system, responsive to determining a hazard is within a threshold distance of a predicted path of the equipped vehicle, and responsive to processing image data captured by at least one camera of the plurality of surround view cameras, displays on the video display video images derived at least in part from image data captured by the forward viewing camera and at least one selected from the group consisting of (i) the first sideward viewing camera and (ii) the second sideward viewing camera, and wherein the displayed video images include a portion of the hazard.

18. The vehicular vision system of claim 17, wherein the hazard comprises one selected from the group consisting of (i) a curb, (ii) a barrier, (iii) a puddle, and (iv) a stone.

19. The vehicular vision system of claim 1, wherein the equipped vehicle travels along the traffic lane of the road at a speed greater than 35 miles per hour.

20. A vehicular vision system, the vehicular vision system comprising:
a plurality of surround view cameras disposed at a vehicle equipped with the vehicular vision system and viewing exterior of the equipped vehicle, each camera of the plurality of surround view cameras capturing image data;
wherein the plurality of surround view cameras comprises a rear backup camera disposed at a rear portion of the equipped vehicle that views at least rearward of the equipped vehicle and a forward viewing camera disposed at a front portion of the vehicle that views at least forward of the equipped vehicle;
wherein the plurality of surround view cameras comprises a first sideward viewing camera disposed at a first side of the equipped vehicle and viewing at least sideward at the first side of the equipped vehicle and a second sideward viewing camera disposed at a second side of the equipped vehicle and viewing at least sideward at the second side of the equipped vehicle;
wherein each camera of the plurality of surround view cameras comprises a CMOS imaging array, and wherein each CMOS imaging array comprises at least one million photosensors arranged in rows and columns;
an electronic control unit (ECU) comprising electronic circuitry and associated software;
a video display screen disposed in the equipped vehicle and viewable by a driver of the equipped vehicle for displaying video images derived from image data captured by the plurality of surround view cameras;
wherein the electronic circuitry of the ECU comprises an image processor for processing image data captured by the plurality of surround view cameras;
wherein, with the equipped vehicle traveling along a traffic lane of a road, the vehicular vision system, responsive to determining an impending lane change of the equipped vehicle toward an adjacent traffic lane at the first side of the equipped vehicle, and responsive to processing at the ECU of image data captured by at least the first sideward viewing camera, displays on the video display video images derived at least in part from image data captured by (a) the first sideward viewing camera and (b) at least one selected from the group consisting of (i) the rear backup camera and (ii) the forward viewing camera;
wherein the displayed video images comprise a graphical overlay, and wherein the graphical overlay comprises a three-dimensional vehicular avatar representing location of the equipped vehicle within the displayed video images, and wherein the displayed video images are representative of a virtual point of view, and wherein location of the virtual point of view relative to the equipped vehicle is based on the determined impending lane change; and
wherein displayed video images include a portion of the adjacent traffic lane.

21. The vehicular vision system of claim 20, wherein the first sideward viewing camera is disposed at a first-side exterior rearview mirror assembly of the equipped vehicle and the second sideward viewing camera is disposed at a second-side exterior rearview mirror assembly of the equipped vehicle.

22. The vehicular vision system of claim 20, wherein the vehicular vision system determines the impending lane change based at least in part on image processing at the ECU of image data captured by any camera of the plurality of surround view cameras.

23. The vehicular vision system of claim 20, wherein, responsive to determining, via processing at the ECU of image data captured by at least the first sideward viewing camera, another vehicle in the adjacent traffic lane at the first side of the equipped vehicle and at least partially rearward of the equipped vehicle, the virtual point of view is at an elevated location forward of the equipped vehicle and toward the second side of the equipped vehicle, and wherein the video display displays video images derived at least in part from image data captured by (a) the first sideward viewing camera and (b) the forward viewing camera.

24. A vehicular vision system, the vehicular vision system comprising:
a plurality of surround view cameras disposed at a vehicle equipped with the vehicular vision system and viewing exterior of the equipped vehicle, each camera of the plurality of surround view cameras capturing image data;
wherein the plurality of surround view cameras comprises a rear backup camera disposed at a rear portion of the equipped vehicle that views at least rearward of the equipped vehicle and a forward viewing camera disposed at a front portion of the vehicle that views at least forward of the equipped vehicle;
wherein the plurality of surround view cameras comprises a first sideward viewing camera disposed at a first side of the equipped vehicle and viewing at least sideward at the first side of the equipped vehicle and a second sideward viewing camera disposed at a second side of the equipped vehicle and viewing at least sideward at the second side of the equipped vehicle;
wherein each camera of the plurality of surround view cameras comprises a CMOS imaging array, and wherein each CMOS imaging array comprises at least one million photosensors arranged in rows and columns;
an electronic control unit (ECU) comprising electronic circuitry and associated software;
a video display screen disposed in the equipped vehicle and viewable by a driver of the equipped vehicle for displaying video images derived from image data captured by the plurality of surround view cameras;
wherein the electronic circuitry of the ECU comprises an image processor for processing image data captured by the plurality of surround view cameras;
wherein, with the equipped vehicle traveling along a traffic lane of a road at a speed greater than 20 miles per hour, the vehicular vision system, responsive to determining an impending lane change of the equipped vehicle toward an adjacent traffic lane at the first side of the equipped vehicle, and responsive to processing at the ECU of image data captured by at least the first sideward viewing camera, displays on the video display video images derived at least in part from image data captured by (a) the first sideward viewing camera and (b) at least one selected from the group consisting of (i) the rear backup camera and (ii) the forward viewing camera;
wherein the vehicular vision system determines the impending lane changed based on an output from a navigation function of the equipped vehicle; and
wherein displayed video images include a portion of the adjacent traffic lane.

25. The vehicular vision system of claim 24, wherein the video images are derived from at least three cameras of the plurality of surround view cameras.

26. The vehicular vision system of claim 24, wherein the displayed video images comprise a simulated 360 degree bird's-eye view of the equipped vehicle.
